(19) United States
(12) Patent Application Publication
(10) Pub. No.: US 2015/0358836 A1
(43) Pub. Date: Dec. 10, 2015

(54) METHOD AND APPARATUS FOR DL/UL RESOURCE CONFIGURATION IN A TDD SYSTEM

(71) Applicant: NEC (CHINA) CO., LTD., Beijing (CN)

(72) Inventors: Dalin ZHU, Beijing (CN); Yu ZHANG, Beijing (CN); Zhennian SUN, Beijing (CN); Chaofeng LI, Beijing (CN); Gang WANG, Beijing (CN); Ming LEI, Beijing (CN)

(73) Assignee: NEC (CHINA) CO., LTD., Beijing (CN)

(21) Appl. No.: 14/759,338

(22) PCT Filed: Jan. 16, 2013
(86) PCT No.: PCT/CN2013/070528

§ 371 Date: Jul. 6, 2015

(51) Int. Cl. H04W 24/02; H04W 72/04

(52) U.S. Cl. CPC H04W 24/02; H04W 72/0446; H04W 84/045

(57) ABSTRACT

Embodiments of the present disclosure relate to a method and apparatus for DL/UL resource configuration in a Time Division Duplex (TDD) system. The method may comprise: dividing a plurality of cells into disjoint clusters based on interference conditions among base stations of the plurality of cells; and performing, in each of at least one of the disjoint clusters, a cooperation DL/UL resource configuration on in-cluster cells included therein based on traffic conditions and performance metrics of the in-cluster cells, so as to determine respective DL/UL resource configurations for the in-cluster cells. With embodiments of the present disclosure, time domain resources may be utilized more efficiently and, additionally, it may be expected to achieve a better overall performance at a low cost.

### FIELD OF THE INVENTION

Embodiments of the present disclosure generally relate to wireless communication techniques and more particularly relate to a method and apparatus for downlink (DL)/uplink (UL) resource configuration in a Time Division Duplex (TDD) system.

### BACKGROUND OF THE INVENTION

With the fast development of the wireless communication data service, requirements on data rate and the coverage quality are constantly increasing. In the 3rd Generation Partnership Project (3GPP) long-term evolution advanced (LTE-A), there are proposed Heterogeneous Network (HetNet) technologies to improve the network performance. In a HetNet, there are deployed, for example, a Marcocell, a RRH and s small-type base station node operating at a low power, such as picocell, femtocell, relay, and etc. With the small-type base station node, a distance between an end user and a base station is shorten greatly and quality of receive signals can be enhanced, and furthermore, the transmission rate, the spectrum efficiency and the coverage for cell edge users can also be improved.

However, the use of a plurality of base stations might introduce some problems, especially interferences. For example, the Marcocell will interfere with the small-type base station such as the picocell, femtocell, or relay when it transmits signals, and vice visa; a User Equipment (UE) might also interfere with other UEs when it transmits signals to a base station.

Additionally, in the Time Division LTE (TD-LTE) system, there has been advantageously proposed an asymmetrical DL/UL resource configuration scheme as so to adapt to the asymmetrical DL/UL data traffic. In the scheme, there is provided seven different semi-statically DL/UL configurations, which are schematically illustrated in FIG. 1.

As illustrated in FIG. 1, a TDD radio frame consists of ten subframes labeled with 0 to 9. Each of the subframes may be used for DL transmission or UL transmission, or used as a special subframe between the DL period and the UL period. Taking configuration 0 as an example, subframes 0 and 5 are used for the DL transmission, subframes 2 to 4 and subframes 7 to 9 are used for the UL transmission, and subframes 1 and 6 are used as special subframes, which are labeled as “D”, “U” and “S” respectively.

Such an asymmetrical resource configuration scheme provides different DL/UL configuration patterns from which the base station can select a suitable configuration based on the UL data size and the DL data size. Therefore, this semi-static resource allocation could improve the resource utilization rate. Since traffic requirements may be fluctuating significantly, in some cases, the semi-static resource allocation may not match instantaneous traffic condition. Hence, there might be a need to employ additional mechanisms in a TD-LTE system to adapt to the instantaneous traffic condition. A dynamic DL/UL resource configuration has been proposed, wherein a time-scale for reconfiguration is suggested to be tens/hundreds of milliseconds so as to be more adaptive to the traffic requirements.

By dynamically reconfiguring the DL/UL allocation, the network may benefit from traffic adaptation in both DL and UL directions. However, in such a dynamical configuration scheme, it might also result in cross-subframe co-channel interference (CCI) due to the mismatched transmission directions in neighboring cells.

A scenario of two cells (Cell 0 and Cell 1) illustrated in FIG. 2A will be taken as an example, wherein Cell 0 uses configuration 5 and Cell 1 uses configuration 6. As illustrated in FIG. 2B, at subframes 3, 4, 7 and 8 which are designated for DL transmission for Cell 0 and for UL transmission for Cell 1 respectively, the DL transmission from RRU0 to user equipment UE 0 will be interfered greatly by the UL transmission Cell 1, i.e., there will be a UE-UE CCI as illustrated in FIG. 2A; similarly, the reception quality of remote radio unit RRU 1 in Cell 1 would also be degraded due to the power leakage from RRU0 in Cell 0 during its downlink transmission, i.e., RRU-RRU CCI as illustrated in FIG. 2B. Hence, the benefits obtained by adaptive DL/UL allocation would be dramatically undermined due to these CCIs.

Therefore, there is a need for a new technical solution for resource allocation in the art.

### SUMMARY OF THE INVENTION

In view of the foregoing, the present disclosure provides a new solution for resource allocation in a TDD system so as to solve or at least partially mitigate at least a part of problems in the prior art.

According to a first aspect of the present disclosure, there is provided a method for DL/UL resource configuration in a TDD system. The method may comprise dividing a plurality of cells into disjoint clusters based on interference conditions among base stations of the plurality of cells; and performing, in each of at least one of the disjoint clusters, a cooperation DL/UL resource configuration on in-cluster cells included therein based on traffic conditions and performance metrics of the in-cluster cells, so as to determine respective DL/UL resource configurations for the in-cluster cells.

In an embodiment of the present disclosure, the performing a cooperation DL/UL resource configuration on in-cluster cells may comprise: assigning subframe configurations to the in-cluster cells by performing an optimization resource configuration operation with an optimization objective of an overall performance metric that combines the traffic conditions and the performance metrics of the in-cluster cells.

In another embodiment of the present disclosure, the performing an optimization resource configuration operation may comprise obtaining history information on the performance metrics for at least part of all possible subframe patterns, wherein a subframe pattern indicates a subframe combination at a same subframe in configurations for the cells; obtaining information on the traffic conditions of the in-cluster cells; and searching, based on the history information on the performance metrics and the information on the traffic conditions, configurations for the in-cluster cells, which can achieve an optimal overall performance metric.

In a further embodiment of the present disclosure, the at least part of possible subframe patterns may comprise subframe patterns each involving both a subframe for downlink transmission and a subframe for uplink transmission.

In a still further embodiment of the present disclosure, the performing an optimization resource configuration operation may further comprise determining initial configurations for the in-cluster cells based on their respective traffic conditions and/or transmission capabilities.

In a yet further embodiment of the present disclosure, the performing an optimization resource configuration operation may be based on a trellis exploration algorithm.

In a still yet further embodiment of the present disclosure, the number of cells in a cluster may be limited to a predetermined value

In another embodiment of the present disclosure, the method may be re-performed in response to triggering of resource reconfiguration.

In a still anther embodiment of the present disclosure, the performance metrics may comprise one or more of: downlink throughput performance; uplink throughput performance; overall system throughput; signal quality; and traffic condition match.

In a yet another embodiment of the present disclosure, t the interference conditions among base stations of the plurality of cells may comprise one or more of inter-cell distance; path loss among cells; coupling loss among cells; history interference measurements; history downlink/uplink throughputs; and history subframe configurations.

According to a second aspect of the present disclosure, there is also provided an apparatus for resource allocation in a TDD system. The apparatus may comprise: a cell clustering unit configured to divide a plurality of cells into disjoint clusters based on interference conditions among base stations of the plurality of cells; and a resource configuration unit configured to perform, in each of at least one of the disjoint clusters, a cooperation DL/UL resource configuration on in-cluster cells included therein based on traffic conditions and performance metrics of the in-cluster cells, so as to determine respective DL/UL resource configurations for the in-cluster cells.

According to a third aspect of the present disclosure, there is further provided, a computer-readable storage media with computer program code embodied thereon, the computer program code configured to, when executed, cause an apparatus to perform actions in the method according to any one of embodiments of the first aspect.

According to a fourth aspect of the present disclosure, there is provided a computer program product comprising a computer-readable storage media according to the third aspect.

With embodiments of the present disclosure, time domain resources may be utilized more efficiently and, additionally, it may be expected to achieve a better overall performance at a low cost.

### BRIEF DESCRIPTION OF THE DRAWINGS

The above and other features of the present disclosure will become more apparent through detailed explanation on the embodiments as illustrated in the embodiments with reference to the accompanying drawings throughout which like reference numbers represent same or similar components and wherein:

FIG. 1 schematically illustrates a diagram of DL/UL configurations in LTE TDD system as specified by 3GPP;

FIG. 2A schematically illustrates an example of CCIs in a two-cell scenario;

FIG. 2B schematically illustrates subframes at which CCI may be caused in the scenario of FIG. 2A;

FIG. 3 schematically illustrates a network in which embodiments of the present disclosure may be implemented;

FIG. 4 schematically illustrates a flow chart of a method for DL/UL resource configuration in a TDD system according to an embodiment of the present disclosure;

FIG. 5 schematically illustrates a diagram of clustering according to an embodiment of the present disclosure;

FIG. 6A schematically illustrates diagrams of exemplary configuration patterns according to an embodiment of the present disclosure;

FIG. 6B schematically illustrates diagrams of exemplary subframe patterns according to an embodiment of the present disclosure;

FIG. 7 schematically illustrates a cooperation DL/UL resource configuration according to an embodiment of the present disclosure;

FIG. 8 schematically illustrates a cooperation DL/UL resource configuration based on a trellis exploration algorithm according to an embodiment of the present disclosure;

FIG. 9 schematically illustrates a block diagram of an apparatus for DL/UL resource configuration in a TDD system according to an embodiment of the present disclosure;

FIG. 10 illustrates the cumulative density (CDF) of the RRU-RRU MCL;

FIG. 11 illustrates cell-average DPT and UPT for three different cases wherein λ_{DL}=0.5 and δ=0.5; and

FIG. 12 illustrates cell-edge DPT and UPT for three different cases, wherein λ_{DL}=0.5 and δ=0.5.

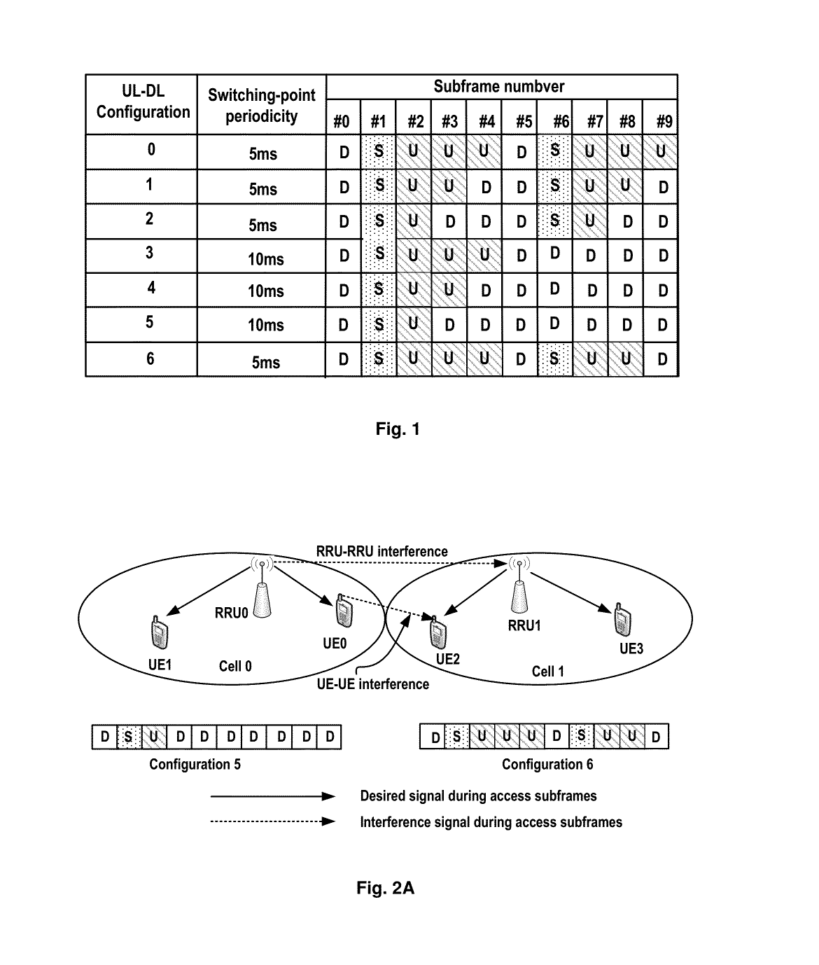

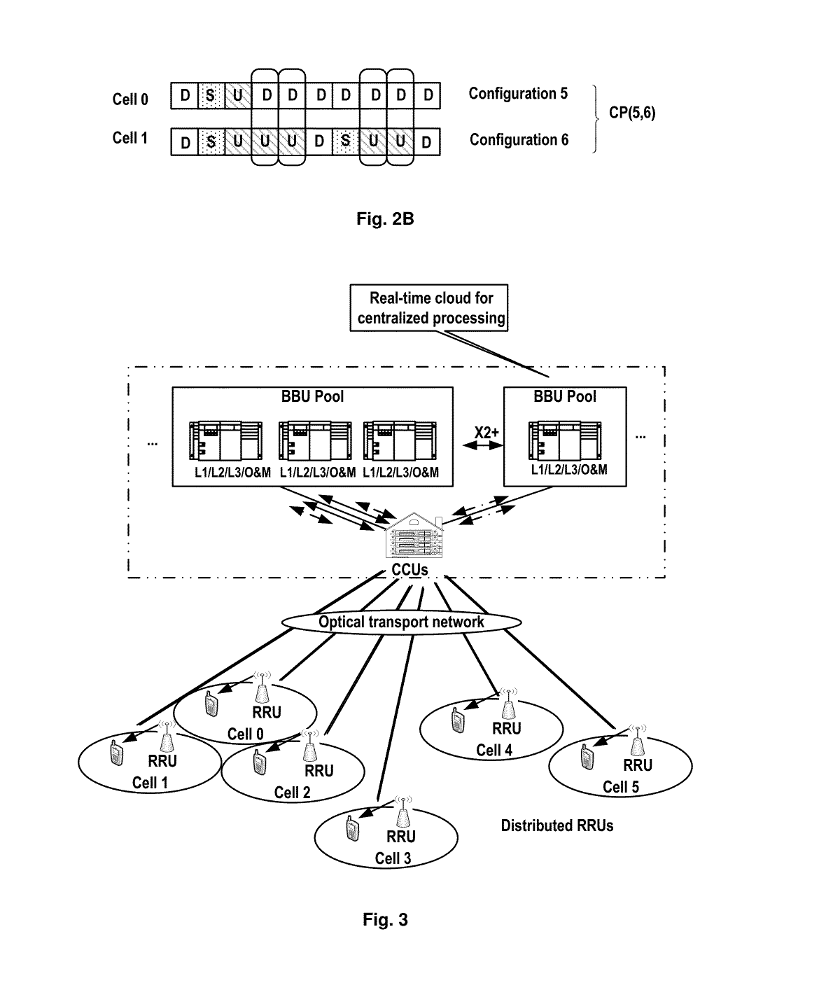

### DETAILED DESCRIPTION OF EMBODIMENTS

Hereinafter, a methods and apparatuses of DL/UL resource configuration in a TDD system will be described in details through embodiments with reference to the accompanying drawings. It should be appreciated that these embodiments are presented only to enable those skilled in the art to better understand and implement the present disclosure, not intended to limit the scope of the present disclosure in any manner.

In the accompanying drawings, various embodiments of the present disclosure are illustrated in block diagrams, flow charts and other diagrams. Each block in the flowcharts or block may represent a module, a program, or a part of code, which contains one or more executable instructions for performing specified logic functions. Besides, although these blocks are illustrated in particular sequences for performing the steps of the methods, as a matter of fact, they may not necessarily be performed strictly according to the illustrated sequence. For example, they might be performed in reverse sequence or simultaneously, which is dependent on natures of respective operations. It should also be noted that block diagrams and/or each block in the flowcharts and a combination of thereof may be implemented by a dedicated hardware-based system for performing specified functions/operations or by a combination of dedicated hardware and computer instructions.

Generally, all terms used in the claims are to be interpreted according to their ordinary meaning in the technical field, unless explicitly defined otherwise herein. All references to “a/an/the/said [element, device, component, means, step, etc]” are to be interpreted openly as referring to at least one instance of said element, device, component, means, unit, step, etc., without excluding a plurality of such devices, components, means, units, steps, etc., unless explicitly stated otherwise. Besides, the indefinite article “a/an” as used herein does not exclude a plurality of such steps, units, modules, devices, and objects, and etc.

Additionally, in a context of the present disclosure, a user equipment (UE) may refer to a terminal, a Mobile Terminal (MT), a Subscriber Station (SS), a Portable Subscriber Station (PSS), Mobile Station (MS), or an Access Terminal (AT), and some or all of the functions of the UE, the terminal, the MT, the SS, the PSS, the MS, or the AT may be included. Furthermore, in the context of the present disclosure, the term “BS” may represent, e.g., a node B (NodeB or NB), an evolved NodeB (eNodeB or eNB), a radio header (RH), a remote radio head (RRH), a relay, or a low power node such as a femto, a pico, and so on.

For a better understanding of the present disclosure, the following description will be made to embodiments of the present disclosure by taking a cloud based TDD heterogeneous networks as an example. However, as can be appreciated by those skilled in the art, the present invention can be applicable to any other suitable communication system.

First, reference will made to FIG. 3 to describe a cloud based TDD heterogeneous networks in which embodiments of the present disclosure may be implemented. As illustrated, in the centralized RAN (Radio Access Network) network, there are densely deployed a plurality of remote radio units (RRUs), a RRU is comparable to a cell and installed at each local site with only radio frequency (RF) front-end functionalities. All RRUs are connected with a central control unit (CCU) through an optical fiber network. All the processing units/capabilities (including a base-band) are pooled at the CCUs. Due to such a centralized RAN architecture, it provides a possibility to formulate the DL/UL reconfiguration as the corporative control and implemented efficiently in the present disclosure.

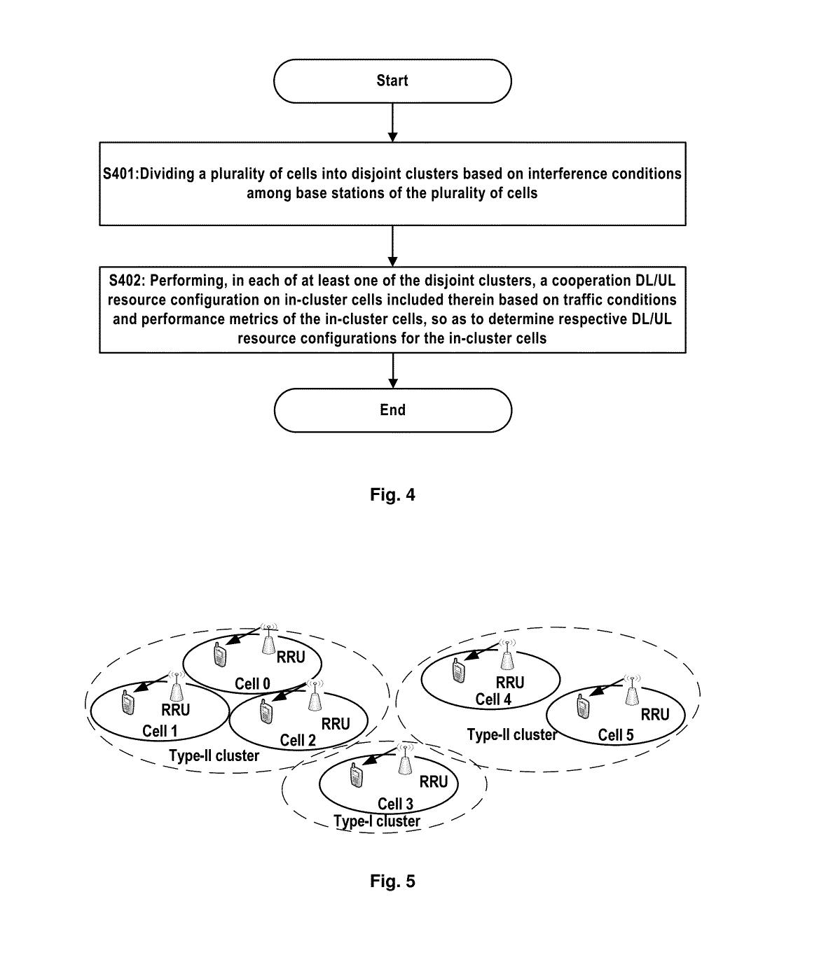

Hereinafter, reference is made to FIG. 4 to describe the method for DL/UL resource configuration in a TTD system as provided in the present disclosure.

As illustrated in FIG. 4, first at S401, a plurality of cells is divided into disjoints clusters based on interference conditions among base stations of the plurality of cells.

In embodiments of the present disclosure, there is proposed to a novel cluster-based dynamic DL/UL reconfiguration scheme. Therefore, in this step, clustering may be first performed so as to divide the cells into a plurality of disjoint clusters. In an embodiment of the present disclosure, the clustering may be carried out based on interference conditions among base stations of the cells. The centrally located BBU as a central controller may monitor the network so as to collect the interference conditions. The interference conditions may comprise, but not limited to inter-cell distance; path loss among cells; coupling loss among cells; history interference measurements; history downlink/uplink throughputs; history subframe configurations or any other metrics that can reflect the interference conditions.

Additionally, the number of cells in a cluster (i.e., the number of in-cluster cells) may also be limited to a predetermined value. The number of the in-cluster cells may relate to the signaling overhead, design degrees of freedom (DoFs), the computation complexity, and so on. Therefore, it will be preferable to limit the number of the in-cluster cells to a reasonable value, which may be determined by considering the above-mentioned factors, i.e., the signaling overhead, DoFs, the computation complexity, and etc. For example, the predetermined value may be set as 3 in advance, that is to say, at most 3 cells can be comprised in a cluster.

The clustering may be dynamically conducted every a predetermined time interval (tens/hundreds of milliseconds). Thus, so-called cluster boundary effect may be well handled due to randomization.

In such a way, the cells will be grouped into disjoint or isolated clusters each containing cells which might highly interfere with each other. For a purpose of illustration, there is shown three disjoint clusters in FIG. 5, i.e., a first cluster containing Cells 0 to 2, a second cluster containing only one cell, i.e., Cell 3, and a third cluster containing Cells 4 and 5.

Then, at step S402, in each of at least one of the disjoint clusters, a cooperation resource allocation on in-cluster cells included therein is performed based on traffic conditions and performance metrics of the in-cluster cells, so as to determine respective DL/UL resource configurations for the in-cluster cells.

As illustrated in FIG. 5, there are three disjoint cell cluster, and these disjoint cell clusters might be divided into two types, i.e., a cell cluster containing only one cell (type I cluster) and a cell cluster containing more than one cells (Type II cluster).

In the type I cluster, there is only one cell and therefore, the cell may freely select their resource configuration without considering other cells. In type II cluster, a cooperation resource allocation may be performed on in-cluster cells included therein, so as to determine respective resource configurations for the in-cluster cells.

The adaptation to traffic condition and the system performance are key points that are concerned. Therefore, the cooperation resource allocation may be carried out based on traffic conditions and performance metrics of the in-cluster cells. Specially, it may assign subframe configurations to the in-cluster cells by performing an optimization resource configuration operation with an optimization objective of an overall performance metric that combines the traffic conditions and the performance metrics of the in-cluster cells.

The traffic conditions refer to conditions about DL traffic, UL traffic for each of the in-cluster cells. Additionally, in embodiments of the present disclosure, the optimization objective, i.e., overall performance metric, may comprise one or more of: downlink throughput performance; uplink throughput performance; overall system throughput; signal quality; and traffic condition match. That is to say, the optimization operation may be performed with a single optimization objective or multiple optimization objectives, which is dependent on practical requirements. Therefore, it might need to obtain some parameters or measurements such as aggregated DL/UL traffic ratio, per subframe/frame history interference measurements, per subframe/frame history DL/UL throughput, history resource configuration and so on.

In an embodiment of the present disclosure, the performing an optimization resource configuration operation may comprise obtaining history information on the performance metrics for at least part of all possible subframe patterns; obtaining information on the traffic conditions of the in-cluster cells; and searching, based on the history information on the performance metrics and the information on the traffic conditions, configurations for the in-cluster cells, which can achieve an optimal overall performance metric.

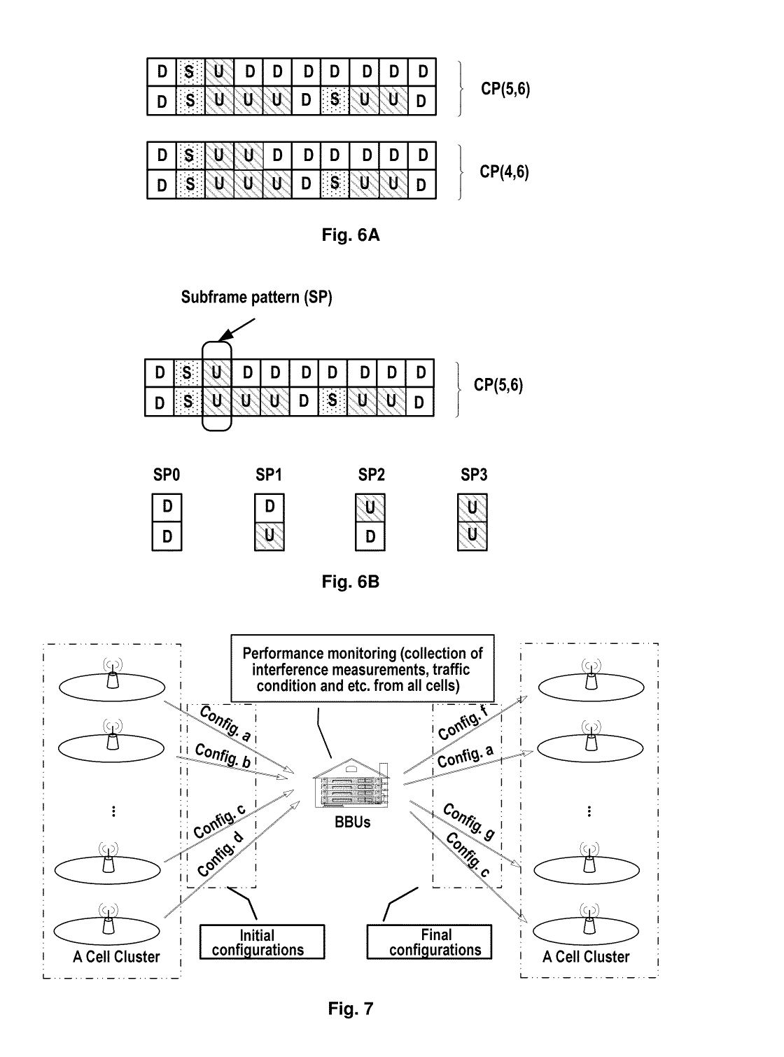

In the present disclosure, there are newly introduced terms “configuration pattern” and “subframe pattern”. The term “configuration pattern” or “CP”, i.e., subframe configuration pattern, means different combinations for subframe configurations assigned to in-cluster cells. FIG. 6A schematically illustrates two different configuration pattern CP{5,6} and CP {4,6}, which represent combinations of DL/UL subframe configurations 5 and 6 and configurations 4 and 6, respectively. The term “subframe pattern” or “SP” means a subframe combination at a subframe for subframe configurations assigned to cells, i.e., a subframe combination at a subframe at configuration pattern, which is illustrated in FIG. 6B. Additionally, FIG. 6B also illustrates four subframe patterns SPs 0 to 3, for a configuration pattern relating two subframe configurations. It may be appreciated that there will be eight SPs for a configuration pattern relating three subframe configurations.

Specifically, history information on performance metrics for the possible subframe patterns and the information on the traffic conditions of the in-cluster cells can be collected by the centralized BBUs or any other suitable units. Then the BBUs may be responsible for searching, based on these information, configurations for the in-cluster cells, which can achieve an optimal overall performance metric. It may adopt any suitable searching algorithm; however, in determining the searching algorithm, it will be preferable, if an algorithm with a low complexity is selected. In embodiments of the present disclosure, it may adopt but not limited to trellis search algorithm, greedy search algorithm, and etc. Additionally, it may be benefit from exhaustive search algorithm if the number of in-cluster cells is limited to a relative low value.

Additionally, it is possible to down-select some of the subframe patterns because crossed subframes are usually those we are more interested, i.e., we only obtain history performance metric information on those subframe pattern involving both a subframe for downlink transmission and a subframe for uplink transmission. For example, for subframe patters as illustrated in FIG. 6B, SP1 and SP2 are so called crossed subframes.

As illustrated in FIG. 7, it may determine initial configurations for the plurality of cells as initial inputs for the searching algorithms. The initial configurations may be determined as configurations which are randomly selected from the seven different DL/UL subframe configurations. However, it may be preferable if the initial configurations are determined based on their respective traffic conditions and/or transmission capabilities. By providing such initial configuration as inputs to the searching algorithm such as a trellis exploration algorithm, it will provide an optimal allocation results as final configuration results.

It should be noticed that configuration/reconfiguration may be performed every a predetermined time interval (such as tens/hundreds of milliseconds) to well adapt the traffic condition variations in networks. That is to say, the resource allocation operation may be performed again in response to triggering of resource reconfiguration. Additionally, the trigging of resource reconfiguration can also be made dynamically, for example based on network conditions.

More details about the cell clustering and resource allocation operation will be described with reference to exemplary embodiments of the present disclosure, which are given to enable the skilled in the art to better understand the solution as proposed herein. However, it should be appreciated that these exemplary embodiments are provided only for a purpose of illustration instead of limitation. The present invention may be implemented without details described with the exemplary embodiments.

### Cell Clustering Based on Mutual Coupling Loss (MCL)

In the specific implementation, the mutual coupling loss (MCL) may be selected as a clustering criteria despite the fact that many other cluster criteria as mentioned hereinabove may be used. Additionally, the number of cells in a cell is limited to three at maximum.

First, the CCI power from one RRU (RRU0) to another RRU (RRU 1) may be calculated as

I_{RRU0->RRU1}=P_{RRU0}+TAG_{RRU0}+RAG_{RRU1}−PL_{RRU0-RRU1} (Equation 1)

where P_{RRU0} represents a transmitted signal power from RRU0; TAG_{RRU0} and RAG_{RRU1} denote transmit and receive antenna gains of RRU0 and RRU1, respectively (generally TAG_{RRU0} is equal to RAG_{RRU1} for all RRUs); PL RRU0-RRU1 is a propagation loss between RRU0 and RRU1. Herein, the propagation loss PL_{RRU0-RRU1} includes a penetration loss, a path-loss and a shadowing effect. From Equation 1, the MCL between RRU0 and RRU1 may be represented as:

MCL_{RRU0-RRU1}=TAG_{RRU0}+RAG_{RRU1}−PL_{RRU0-RRU1} (Equation 2)

From Equation 2, it may be seen that the MCL between RRUs characterizes the loss in signals between RRUs. In practice, MCL_{RRU0-RRU1} is a negative value, which means that the larger the MCL is, the more attenuations the transmitted signals would suffer from. In addition, the MCL can be easily measured by each individual RRU as well. Hence, the MCL between RRUs may be employed as the metric in performing the cell clustering. All RRUs may report their MCL measurements to the CCUs, which enable the cell clustering in a centralized manner.

In the following, there is given an exemplary cell clustering algorithm for an illustration purpose; however, it should be appreciated that the clustering may be performed by utilizing any suitable algorithms.

Algorithm Proposed cell clustering algorithm

| | |
|---|---|
| 1: | Input: MCL_{RRUO-RRU1};MCL_{RRUO-RRU2}, ... MCL_{RRUx-RRUy}_{,,}... ;τ |
| | ;N_{RRU} |
| 2: | Output: Clustering of RRUs |
| 3: | while All cell clusters are formed do |

| | |
|---|---|
| 4: | start: randomly select one RRU (RRUx) that has not been chosen |
| | so far |
| 5: | initialize: the cell cluster set anchored at RRUx (i.e., {CCx}) |
| 6: | for n = 1; ... ;N_{RRU} do |

| | |
|---|---|
| 7: | if n≠x then |

| | |
|---|---|
| 8: | find the three largest MCLs to RRUx |

| | |
|---|---|
| 9: | end if |

| | |
|---|---|
| 10: | end for |
| 11: | the corresponding three RRUs are RRUₐ, RRU_{b} and RRU_{c} |
| 12: | for m = a; b; c do |

| | |
|---|---|
| 13: | if MCL_{RRUx-RRUm} ≧ τ then |
| 14: | {CCx} ← RRUm |
| 15: | end if |

| | |
|---|---|
| 16: | end for |

| | |
|---|---|
| 17: | end while |

In the algorithm as given in the above, where parameter τ denotes a MCL threshold and N_{RRU} represents the total number of RRUs. The algorithm is started by randomly selecting one RRU as the anchor point. Other RRUs that have larger MCLs than the predetermined MCL threshold to the anchor RRU would be categorized into the same cluster, i.e., highly interfered RRUs are grouped into the same cluster. Additionally, the maximum number of RRUs in one cluster is set as three and the predetermined MCL threshold is set to be −70 dB, which actually is the minimum coupling loss defined in related 3GPP specifications.

This clustering process may continue for the rest of RRUs until all cells of interest are divided into disjoint cell clusters. As has mentioned hereinabove, the cell clustering may be dynamically conducted every tens/hundreds of milliseconds. By doing so, the so-called cluster boundary effect can be well handled due to the randomization.

After the cell clustering, it will generally obtain a plurality of disjoint cell clusters. As has mentioned hereinabove, these disjoint cell clusters would be divided into two types i.e., type-I cluster that contains only one cell and type-II cluster that contains more than one cells.

For a type-I cluster which contains only one cell, the cell can freely adjust its DL/UL subframe configuration based on its traffic condition since there will be relatively low CCI between the cell and a cell in another cluster. For type-II clusters, it requires to perform a cooperative resource configuration and detailed description thereabout will be given hereinafter.

### Cluster-Based Dynamic UL/DL Resource Configuration

Under exemplary embodiments of the present disclosure, the DL/UL resource configuration/reconfiguration is formulated as the corporative control on the basis of cell clusters. Besides, transmission directions in cells belonging to either the same cluster or different clusters are allowed to be different in a subframe. However, the determination of appropriate DL/UL allocations should satisfy the predefined optimization objectives.

Hereinblow, subframe patterns (SP) for two-cell scenario (a cluster contains two cells (Cell 0, Cell 1)) with two possible transmission directions (DL and UL subframes) will be described first with reference to Table 1, wherein D denotes a subframe for DL transmission and U denotes a subframe for UL transmission.

TABLE 1
SP and the corresponding SP index for a two-cell scenario

| Cell 0 | Cell 1 | SP index |
|---|---|---|
| D | D | 0 |
| D | U | 1 |
| U | D | 2 |
| U | U | 3 |

For a two-cell scenario with two possible transmission directions, there will be a total of four SPs that covers all possible combinations of transmission directions. These SPs can be applied to characterize any given configuration pattern (CP) employed by a cluster. For example, for CP{5; 6} which contains configurations 5 and 6, it may be represented by SP as {SP0, SP0, SP3, SP1, SP1, SP0, SP0, SP1, SP1, SP0}, wherein a special subframe is approximate to a DL subframe. From the exemplary SPs as illustrated in Table 1, the skilled in the art may readily understand SPs for scenario containing more than two cells in a cluster, which will not be elaborated herein.

System performance metric information, such as some statistics information, could be collected with respect to each SP. The time interval (TI) of collecting such information starts from last time's cell clustering and ends at this time's configuration/reconfiguration. This would ensure that the system information is collected under the same interference scenario. In these exemplary embodiments of the present disclosure, the overall system throughput will be taken as the objective of optimization despite the fact that many other objectives may be used.

The throughput μᵢ on each SP may be obtained as follows:

μᵢ=αᵢ C̅_{0,i}^{DL}+(1−αᵢ) C̅_{0,j}^{UL}+βᵢ C̅_{1,i}^{DL}+(1−βᵢ) C̅_{1,j}^{UL} i=0, 1, 2, 3 (Equation 3)

wherein i is the index of SP; C̅_{0,i}^{DL} and C̅_{0,i}^{UL} are average DL and UL subframe throughputs of Cell 0 with respect to SPᵢ, calculated by averaging all the SPᵢ related DL and UL subframe throughputs collected over the corresponding time interval (TI), respectively; C̅_{1,i}^{DL} and C̅_{1,i}^{UL} are average DL and UL subframe throughputs of Cell 1 with respect to SPᵢ; αᵢ and βᵢ are two binomial random variables with respect to SPᵢ, which are respectively defined as

$$\begin{matrix}{α}_{i} = \{ \begin{matrix}1 ; if DL subframe in Cell 0 \\ 0 ; otherwise\end{matrix} & ( Equation 4 ) \\ {β}_{i} = \{ \begin{matrix}1 ; if DL subframe in Cell 1 \\ 0 ; otherwise\end{matrix} & ( Equation 5 )\end{matrix}$$

Thus, in the CCUs, it may built a look-up table that stores and updates the statistical throughput information corresponding to each SP, which is illustrated in Table 2 as an exemplary embodiment of the present disclosure.

TABLE 2
SP index and corresponding throughput for the two-cell scenario

| SP index | Throughput information |
|---|---|
| 0 | μ₀ |
| 1 | μ₁ |
| 2 | μ₂ |
| 3 | μ₃ |

As described hereinbefore, the proposed reconfiguration scheme is conducted on the basis of cell cluster, that is, the DL/UL configurations are no longer determined with respect to each individual cell, but are chosen in form of the CP. Straightforwardly, for a two-cell scenario with seven possible DL/UL configurations, the total number of candidate CPs is 7*7=49 and each candidate CP can be interpreted by a combination of SPs, as described hereinabove. If CP(5; 6) is to be employed, it may be interpreted as {SP0, SP0, SP3, SP1, SP1, SP0, SP0, SP1, SP1, SP0} with five SP0s, four SP1s and one SP3. Therefore, by using the SP-specific statistical throughput information stored and updated in the look-up table as illustrated in Table 2, the corresponding overall system throughput can be estimated/predicted as

$${C}_{est}^{CP ( 5 , 6 )} = \frac{X}{10} ( 5 {μ}_{0} + 4 {μ}_{1} + {μ}_{3} ) \qquad ( Equation 6 )$$

Here, X ms is the time-scale for reconfiguration and is usually the multiple integer of 10 ms. Hence, for each candidate CP, we can estimate/predict the corresponding overall system throughput for a period of Xms. The candidate CP that has the maximum overall system throughput for the upcoming Xms would be selected for reconfiguration. This process can be formulated as:

CP(lₐ,l_{b})=arg maxₗ_{ₓ}_{,l}_{_{y}}_{ε{0,1, . . . 6}}Cₑₛₜ^{CP(l}^{ₓ}^{,l}^{_{y}}⁾ (Equation 7′)

where lₐ and l_{b} are the indices of the chosen DL/UL configurations for Cell 0 and Cell 1, respectively.

However, the network with maximized overall system throughput may not necessarily be adaptive to the asymmetric DL and UL traffic demands. Hence, μᵢ needs to be properly scaled taking this asymmetry into account. For the two-cell scenario, traffic demands v₀^{D} and v₁^{D} for DL transmission in Cell 0 and Cell 1 and traffic demands v₀^{U} and v₁^{U} for UL transmission in Cell 0 and Cell 1 may be respectively represented as:

$$\begin{matrix}{v}_{0}^{D} = \frac{{B}_{0}^{D}}{{B}_{0}^{D} + {D}_{1}^{D}} \\ {v}_{1}^{D} = \frac{{B}_{1}^{D}}{{B}_{0}^{D} + {B}_{1}^{D}} & ( Equation 8 ) \\ {v}_{0}^{U} = \frac{{B}_{0}^{U}}{{B}_{0}^{U} + {B}_{1}^{U}} \\ {v}_{1}^{U} = \frac{{B}_{1}^{U}}{{B}_{0}^{U} + {B}_{1}^{U}} & ( Equation 9 )\end{matrix}$$

wherein B₀^{D} and B₁^{D} denote the number of packets in the DL buffers of Cell 0 and Cell 1, respectively; B₀^{U} and B₁^{U} represent the number of packets in the UL buffers of Cell 0 and Cell 1, respectively. Besides, the asymmetry of the DL and UL traffic requirements within Cell 0 and Cell 1 may be represented as:

$${k}_{0}^{U} = \frac{{B}_{0}^{U}}{{B}_{0}^{D}} \\ {k}_{1}^{U} = \frac{{B}_{1}^{U}}{{B}_{1}^{D}} \qquad ( Equation 10 )$$

Therefore, the throughput on each SP as given in Equation 3 may be further represented as:

μᵢ=v₀^{D}αᵢ C̅_{0,i}^{DL}+v₀^{D}k₀^{U}v₀^{U}(1−αᵢ) C̅_{0,i}^{UL}+v₁^{D}βᵢ C̅_{1,i}^{DL}+v₁^{D}k₁^{U}v₁^{U}(1−βᵢ) C̅_{1,i}^{UL} (Equation 11)

By applying the modified in Equations 6 and 7, it may obtain a promising CP for reconfiguration which has considered both system performance and traffic demands.

So far, the cluster-based dynamic DL/UL reconfiguration has been described with reference to a two-cell scenario. However, it should be appreciated that Equations 3 to 11 can be easily extended to more general expressions if more than two cells are included in a same cluster. In addition, in the present disclosure, the time-scale for clustering is much larger than that for reconfiguration which would ensure that the calculations of Equations 6 and 7 could be carried out under the same interference scenario.

Additionally, it may be noted that the computational complexity of Equation 7 would dramatically increase with increase in the cluster size. Hence, finding the optimal CPs via exhaustive search would be time consuming even though all the processing units are pooled at the CCUs. Therefore, it will be preferable to adopt a low complexity. Hereinbelow, a low complexity algorithm will be described for a purpose of illustration.

### Trellis Exploration Algorithm for DL/UL Resource Configuration

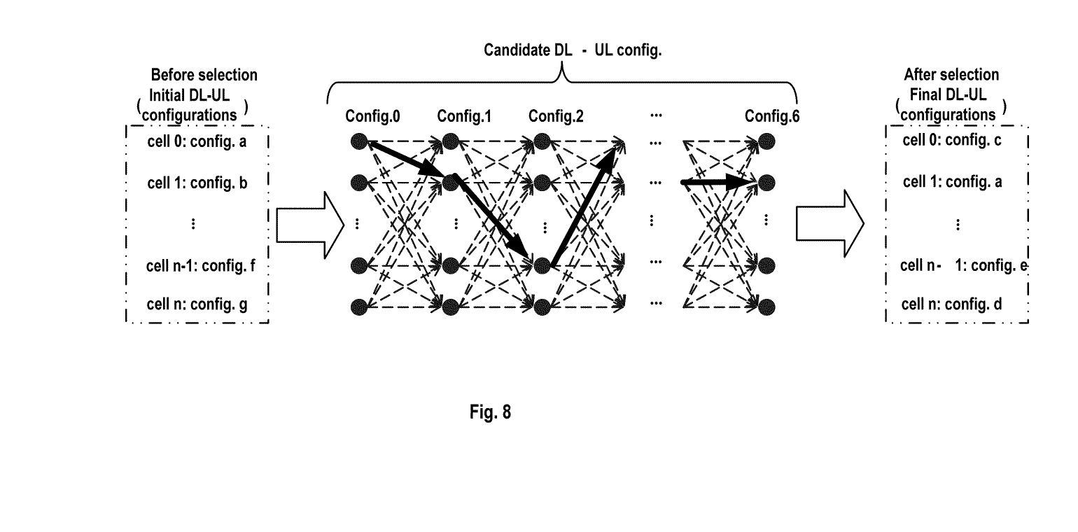

Herein, there is proposed to use a low complexity algorithm, named trellis exploration algorithm to find the sub-optimal CPs for reconfiguration. The schematic diagram corresponding to the trellis exploration algorithm is given in FIG. 8.

As illustrated, there are seven state transitions with each of them corresponding to a different candidate DL/UL configuration. Each transition point has several nodes. If the number of cells within the cluster of interest is N_{RRU}^{C}, the number of nodes regarding each transition point would be N_{RRU}^{C}. Each of nodes corresponds to a separate cell (and therefore, the input DL/UL configuration of that cell) in the cluster. The initial inputs to the trellis diagram may be the N_{RRU}^{C} DL/UL configurations obtained from last time's reconfiguration although they also may be randomly determined configurations or default configurations. The initial configurations will go through the trellis diagram state by state with necessary replacements of some of them by the corresponding candidate DL/UL configurations. More specifically, at each transition point, the corresponding candidate DL/UL configuration will tentatively replace each of the input DL/UL configurations once at a time, forming N_{RRU}^{C}+1 candidate CPs (including the input CP). With respect to each candidate CP, the predefined performance metric is calculated, e.g., performing the calculation of Equation 6 regarding CP(5, 6) in a two-cell scenario. The candidate CP that has the optimal performance metric (e.g., CP(la; lb) in (7) for a two-cell scenario) would be chosen as the input to the next state transition. At the end, the output of the final state would be regarded as the chosen CP for reconfiguration of the cluster of interest. In such a way, the final DL/UL configuration may be determined. However, in some cases, several times of iterations through the trellis diagram may be required.

It is clear that with embodiments of the present disclosure, time domain resources may be utilized more efficiently and, additionally, it may be expected to achieve a better overall performance at a low cost.

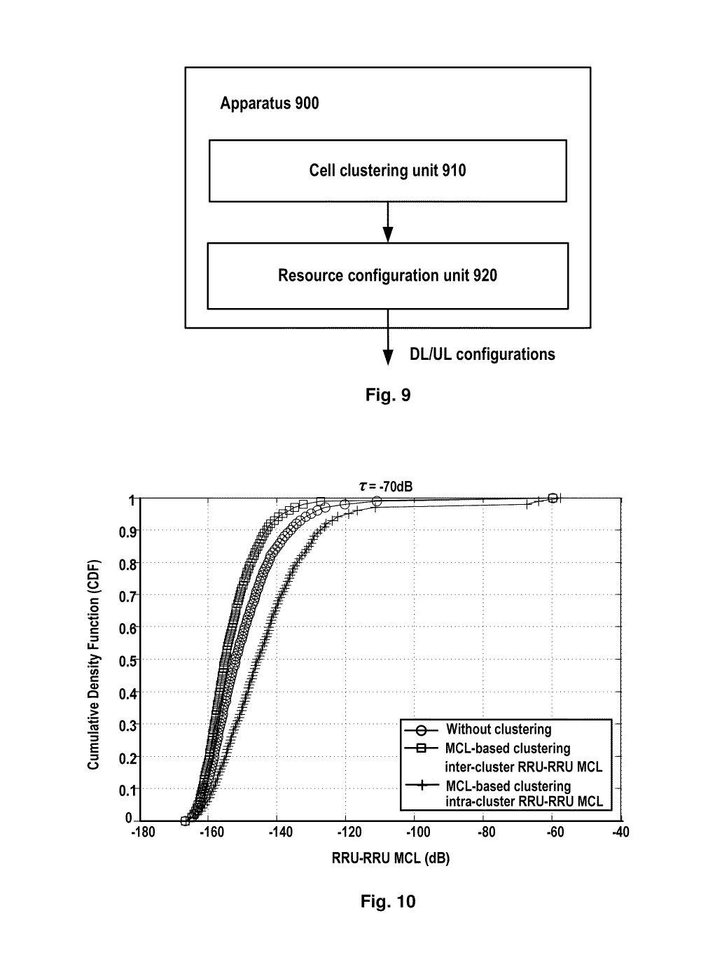

Additionally, in the present disclosure, there is also provided an apparatus for DL/UL resource configuration in a TDD system. Next, reference will be made to FIG. 9 to describe the apparatus as provided in the present disclosure.

As illustrated in FIG. 9, the apparatus 900 may comprise a cell clustering unit 910 and a resource configuration unit 920. The cell clustering unit 910 may be configured to divide a plurality of cells into disjoint clusters based on interference conditions among base stations of the plurality of cells. The resource configuration unit 920 may be configured to perform, in each of at least one of the disjoint clusters, a cooperation DL/UL resource configuration on in-cluster cells included therein based on traffic conditions and performance metrics of the in-cluster cells, so as to determine respective DL/UL resource configurations for the in-cluster cells.

In an embodiment of the present disclosure, the resource configuration unit 920 may be further configured to: assign subframe configurations to the in-cluster cells by performing an optimization resource configuration operation with an optimization objective of an overall performance metric that combines the traffic conditions and the performance metrics of the in-cluster cells.

In another embodiment of the present disclosure, the performing an optimization resource configuration operation may comprise obtaining history information on the performance metrics for at least part of all possible subframe patterns, wherein a subframe pattern indicates a subframe combination at a same subframe in configurations for the cells; obtaining information on the traffic conditions of the in-cluster cells; and searching, based on the history information on the performance metrics and the information on the traffic conditions, configurations for the in-cluster cells, which can achieve an optimal overall performance metric.

In a further embodiment of the present disclosure, the at least part of possible subframe patterns may comprise subframe patterns each involving both a subframe for downlink transmission and a subframe for uplink transmission.

In a still further embodiment of the present disclosure, the performing an optimization resource configuration operation may further comprise determining initial configurations for the in-cluster cells based on their respective traffic conditions and/or transmission capabilities.

In a yet further embodiment of the present disclosure, the performing an optimization resource configuration operation may be based on a trellis exploration algorithm.

In a still yet further embodiment of the present disclosure, the number of cells in a cluster may be limited to a predetermined value.

In another embodiment of the present disclosure, n the apparatus may be configured to re-perform in response to triggering of resource reconfiguration.

In a further embodiment of the present disclosure, the performance metric may comprise one or more of: downlink throughput performance; uplink throughput performance; overall system throughput; signal quality; and traffic condition match.

In a still further embodiment of the present disclosure, the interference conditions among base stations of the plurality of cells may comprise one or more of inter-cell distance; path loss among cells; coupling loss among cells; history interference measurements; history downlink/uplink throughputs; and history subframe configurations.

It is noted that the apparatus 900 may be configured to implement functionalities as described with reference to FIGS. 3 and 8. Therefore, for details about the operations of modules in these apparatus, one may refer to those descriptions made with respect to the respective steps of the methods with reference to FIGS. 3 to 8.

It is further noted that the components of the apparatus 900 may be embodied in hardware, software, firmware, and/or any combination thereof. For example, the components of the apparatus 900 may be respectively implemented by a circuit, a processor or any other appropriate selection device. Those skilled in the art will appreciate that the aforesaid examples are only for illustration not limitation.

In some embodiment of the present disclosure, the apparatus 900 comprises at least one processor. The at least one processor suitable for use with embodiments of the present disclosure may include, by way of example, both general and special purpose processors already known or developed in the future. The apparatus 900 further comprises at least one memory. The at least one memory may include, for example, semiconductor memory devices, e.g., RAM, ROM, EPROM, EEPROM, and flash memory devices. The at least one memory may be used to store program of computer executable instructions. The program can be written in any high-level and/or low-level compliable or interpretable programming languages. In accordance with embodiments, the computer executable instructions may be configured, with the at least one processor, to cause the apparatus 900 to at least perform operations according to the method as discussed with reference to FIGS. 3 to 8.

In addition, FIGS. 10 to 12 further illustrate simulation results made on an embodiment of the present invention and the existing solution in the prior art. Parameters used in the simulations are listed in Table 3.

TABLE 3
Parameters used in the simulations

| Parameter | Assumptions used for simulation |
|---|---|
| System bandwidth | 10 MHz |
| Carrier Frequency | 2 GHz |
| Macro deployment | Typical 7-cell and 3-sectored |
| | hexagon system layout |
| | (it is noted that macro |
| | cells are deployed |
| | but are not activated) |
| RRU deployment | 40 m radius, random deployment |
| Number of RRUs per sector | 4 |
| Minimum distance between | 40 m |
| RRUs | |
| RRU transmit power | 24 dBm |
| RRU antenna gain | 5dBi |
| RRU antenna pattern | 2D, Omni-directional |
| RRU noise figure | 13 dB |
| UE antenna gain | 0 dBi |
| UE noise figure | 9 dB |
| UE power class | 23 dBm |
| Minimum distance between UE | 10 m |
| and RRU | |
| Number of UEs per RRU | 10 |
| UE distribution | Cluster, photspot = 2/3 |
| Shadowing correlation between | 0 |
| UEs | |
| Shadowing correlation between | 0.5 |
| RRUs | |
| Path-loss of RRU to UE | P_{LoS} = 103.8 + 20.9 log 10(R) |
| | P_{NLoS} = 145.4 + 37.5 log 10(R) |
| | For 2 GHz, R in km |
| | Pr(R) = 0.5 − min(0.5, |
| | 5exp(0.156/R)) + |
| | min(0.5, exp(R/0.03)) for LoS |
| Path-loss of RRU to RRU | LoS: if R <2/3 km |
| | P_{LoS} = 98.4 + 20 log 10(R) |
| | Else: P_{NLoS} = 101.9 + 40 log 10(R) |
| | For 2 GHz, R in km |
| | Else: PL = 55.78 + 40 log 10(R) |
| | For 2 GHz, R in m |
| Scheduler | FIFO for single user |
| | PF for multi-user |
| HARQ modeling | N/A |
| RRU antenna config. | {4Tx, 2Rx} |
| UE antenna config. | {1Tx, 2Rx} |
| CP length | Normal in both downlink and uplink |
| Special subframe config. | #8 |
| DL/UL receiver type | MRC with ideal CSI |
| Small-scale fading channel | ITU UMi [13] |
| DL/UL modulation order | QPSK, 16QAM, 64QAM |
| Time scale for reconfiguration | 10 ms |
| Time scale for clustering | 640 ms |
| Reference DL/UL configuration | 0 |
| Shadowing standard deviation | 3 dB for LoS |
| between RRU and UE | 4 dB for NLoS |

In simulations, the DL and UL transmissions are evaluated simultaneously in an integrated simulator. Additionally, an FTP traffic model 1 defined in 3GPP TR36.814 is applied with fixed file size of 0:5 Mbytes. If the DL packet arrival rate is denoted by λ_{DL}, the UL packet arrival rate λ_{UL} can be calculated according to the ratio of the DL/UL packet arrival rate (δ). A packet is randomly assigned to a UE with equal probability. Moreover, the traffic patterns are independently modeled for the DL and UL directions per UE in different cells.

Reference is made to FIG. 10 which illustrates the cumulative density function (CDF) of the RRU-RRU MCLs. From FIG. 10, it may be observed that by performing the proposed MCL-based cell clustering, the intra-cluster RRU-RRU MCL is enhanced. This shows that potentially highly CCI interfered RRUs are grouped into the same cluster. By conducting our proposed corporative reconfiguration method on such clusters, more corporation gains can be expected. Additionally, the corresponding inter-cluster RRU-RRU MCL is significantly reduced.

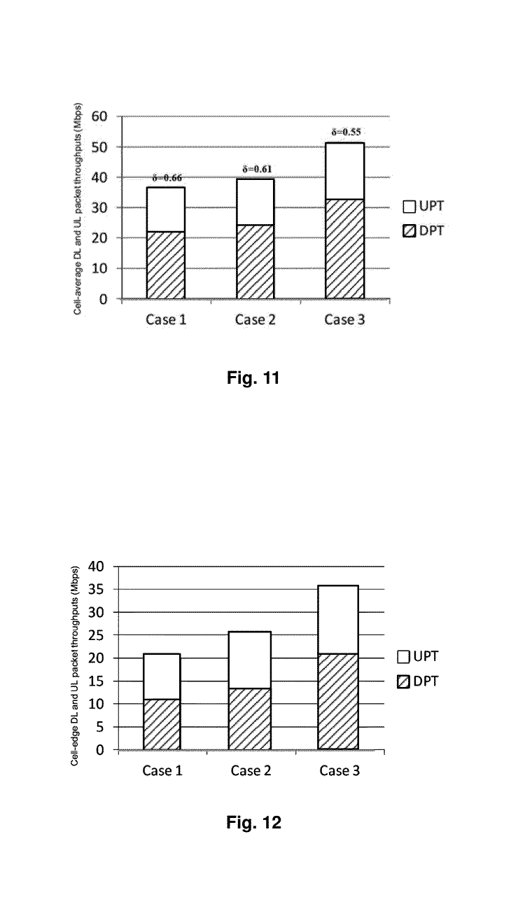

In FIG. 11, evaluation results are provided in terms of the cell-average DL packet throughput (DPT) and UL packet throughput (UPT) performances in three cases. In the simulations, the packet throughput is defined as the packet size over the packet transmission time, including the packet waiting time in the buffer. The three cases are:
Case 1: a static DL/UL reconfiguration, i.e., dynamic DL/UL reconfiguration is disabled and a reference DL/UL configuration will be employed all the time;
Case 2: dynamic DL/UL reconfiguration in the prior art, i.e., each cell will freely configure its own DL/UL resource based on its traffic condition;
Case 3: the cluster-based dynamic DL/UL reconfiguration with the trellis exploration algorithm as proposed in the present disclosure.

Corresponding performance comparisons are conducted in Table 4.

TABLE 4
Comparison of Cell-Average Packet Throughput Performance

| | Case 3 over Case 1 | Case 3 over Case 2 |
|---|---|---|
| DPT Gain | 33.25% | 26.74% |
| UPT Gain | 20.57% | 19.25% |

From FIG. 11 and Table 4, it is clear that case 3 outperforms case 1 and 2 in terms of both DPT, UPT and the overall packet throughput performances. For instance, the proposed scheme in the present disclosure offers 26.74% and 19.25% packet throughput gains relative to the cell-specific DL/UL reconfiguration approach in DL and UL, respectively. Additionally, the actual ratio of the UPT and DPT of case 3 (0.55) is very close to the ratio that generates the DL and UL traffic profiles (0.5).

Additionally, FIG. 12 illustrates the cell-edge packet throughput performances for the three cases and the following Table 5 shows comparison of the cell-edge packet throughput performance.

TABLE 5
Comparison of Cell-Average Packet Throughput Performance

| | Case 3 over Case 1 | Case 3 over Case 2 |
|---|---|---|
| DPT Gain | 46.53% | 35.54% |
| UPT Gain | 34.43% | 17.54% |

It is clear that similar effects could be observed from FIG. 12 and Table 5, wherein the cell-edge packet throughput is defined as the 5% UE average packet throughput that obtained from the CDF of the average packet throughput from all UEs.

It should be noted that in the present disclosure, although embodiments of the present disclosure have been described with reference to CCUs, it is also possible to carry out them by other entity, such as, a BS, a base station controller (BSC), a gateway, a relay, a server, or any other applicable device.

Although embodiments of the present invention have been described with reference to the centralized RAN TDD system, the present invention may also be applicable in any other appropriate TDD system to benefit therefrom.

Besides, the present invention has been described with specific algorithm, but the present disclosure is not limited thereto, any other suitable algorithm may also be employed.

Additionally, based on the above description, the skilled in the art would appreciate that the present disclosure may be embodied in an apparatus, a method, or a computer program product. In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flowcharts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The various blocks shown in the companying drawings may be viewed as method steps, and/or as operations that result from operation of computer program code, and/or as a plurality of coupled logic circuit elements constructed to carry out the associated function(s). At least some aspects of the exemplary embodiments of the disclosures may be practiced in various components such as integrated circuit chips and modules, and that the exemplary embodiments of this disclosure may be realized in an apparatus that is embodied as an integrated circuit, FPGA or ASIC that is configurable to operate in accordance with the exemplary embodiments of the present disclosure.

While this specification contains many specific implementation details, these should not be construed as limitations on the scope of any disclosure or of what may be claimed, but rather as descriptions of features that may be specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Various modifications, adaptations to the foregoing exemplary embodiments of this disclosure may become apparent to those skilled in the relevant arts in view of the foregoing description, when read in conjunction with the accompanying drawings. Any and all modifications will still fall within the scope of the non-limiting and exemplary embodiments of this disclosure. Furthermore, other embodiments of the disclosures set forth herein will come to mind to one skilled in the art to which these embodiments of the disclosure pertain having the benefit of the teachings presented in the foregoing descriptions and the associated drawings.

Therefore, it is to be understood that the embodiments of the disclosure are not to be limited to the specific embodiments disclosed and that modifications and other embodiments are intended to be included within the scope of the appended claims. Although specific terms are used herein, they are used in a generic and descriptive sense only and not for purposes of limitation.

1. A method for downlink (DL)/uplink (UL) resource configuration in a Time Division Duplex (TDD) system, comprising
dividing a plurality of cells into disjoint clusters based on interference conditions among base stations of the plurality of cells; and
performing, in each of at least one of the disjoint clusters, a cooperation DL/UL resource configuration on in-cluster cells included therein based on traffic conditions and performance metrics of the in-cluster cells, so as to determine respective DL/UL resource configurations for the in-cluster cells.

2. The method according to claim 1, wherein the performing a cooperation DL/UL resource configuration on in-cluster cells comprise:
assigning subframe configurations to the in-cluster cells by performing an optimization resource configuration operation with an optimization objective of an overall performance metric that combines the traffic conditions and the performance metrics of the in-cluster cells.

3. The method according to claim 2, wherein the performing an optimization resource configuration operation comprises
obtaining history information on the performance metrics for at least part of all possible subframe patterns, wherein a subframe pattern indicates a subframe combination at a same subframe in configurations for the cells;
obtaining information on the traffic conditions of the in-cluster cells; and
searching, based on the history information on the performance metrics and the information on the traffic conditions, configurations for the in-cluster cells, which can achieve an optimal overall performance metric.

4. The method according to claim 3, wherein the at least part of possible subframe patterns comprises subframe patterns each involving both a subframe for downlink transmission and a subframe for uplink transmission.

5. The method according to claim 2, wherein the performing an optimization resource configuration operation further comprises determining initial configurations for the in-cluster cells based on their respective traffic conditions and/or transmission capabilities.

6. The method according to claim 2, wherein the performing an optimization resource configuration operation is based on a trellis exploration algorithm.

7. The method according to claim 1, wherein the number of cells in a cluster is limited to a predetermined value.

8. The method according to claim 1, wherein the method is re-performed in response to triggering of resource reconfiguration.

9. The method according to claim 1, wherein the performance metrics comprise one or more of:
downlink throughput performance;
uplink throughput performance;
overall system throughput;
signal quality; and
traffic condition match.

10. The method according to claim 1, wherein the interference conditions among base stations of the plurality of cells comprise one or more of
inter-cell distance;
path loss among cells;
coupling loss among cells;
history interference measurements;
history downlink/uplink throughputs; and
history subframe configurations.

11. An apparatus for downlink (DL)/uplink (UL) resource configuration in a Time Division Duplex (TDD) system, comprising
a cell clustering unit configured to divide a plurality of cells into disjoint clusters based on interference conditions among base stations of the plurality of cells; and
a resource configuration unit configured to perform, in each of at least one of the disjoint clusters, a cooperation DL/UL resource configuration on in-cluster cells included therein based on traffic conditions and performance metrics of the in-cluster cells, so as to determine respective DL/UL resource configurations for the in-cluster cells.

12. The apparatus according to claim 11, wherein the resource configuration unit is further configured to:
assign subframe configurations to the in-cluster cells by performing an optimization resource configuration operation with an optimization objective of an overall performance metric that combines the traffic conditions and the performance metrics of the in-cluster cells.

13. The apparatus according to claim 12, wherein the performing an optimization resource configuration operation comprises
obtaining history information on the performance metrics for at least part of all possible subframe patterns, wherein a subframe pattern indicates a subframe combination at a same subframe in configurations for the cells;
obtaining information on the traffic conditions of the in-cluster cells; and
searching, based on the history information on the history performance metrics and the information on the traffic conditions, configurations for the in-cluster cells, which can achieve an optimal overall performance metric.

14. The apparatus according to claim 13, wherein the at least part of possible subframe patterns comprises subframe patterns each involving both a subframe for downlink transmission and a subframe for uplink transmission.

15. The apparatus according to claim 12, wherein the performing an optimization resource configuration operation further comprises determining initial configurations for the in-cluster cells based on their respective traffic conditions and/or transmission capabilities.

16. The apparatus according to claim 12, wherein the performing an optimization resource configuration operation is based on a trellis exploration algorithm.

17. The apparatus according to claim 11, wherein the number of cells in a cluster is limited to a predetermined value.

18. The apparatus according to claim 11, wherein the apparatus is configured to re-perform in response to triggering of resource reconfiguration.

19. The apparatus according to claim 11, wherein the performance metrics comprise one or more of:
downlink throughput performance;
uplink throughput performance;
overall system throughput;
signal quality; and
traffic condition match.

20. The apparatus according to claim 11, wherein the interference conditions among base stations of the plurality of cells comprise one or more of inter-cell distance;
path loss among cells;
coupling loss among cells;
history interference measurements;
history downlink/uplink throughputs; and
history subframe configurations.
